(19) United States
(12) Patent Application Publication
(10) Pub. No.: US 2018/0335058 A1
(43) Pub. Date: Nov. 22, 2018

(54) Support fitting for a translation control system

(71) Applicant: Airbus Operations SAS, Toulouse (FR)

(72) Inventor: Jérôme PHALIPPOU, TOURNEFEUILLE (FR)

(21) Appl. No.: 15/980,848

(22) Filed: May 16, 2018

(30) Foreign Application Priority Data
May 16, 2017 (FR) 1754281

(51) Int. Cl. F15B 20/00; F16B 31/00

(52) U.S. Cl. CPC F15B 20/007; F15B 15/14; F16B 31/00

(57) ABSTRACT

A fitting in a mechanical control system having a jack for the displacement of an actuator. When a stroke of the jack is impeded by a problem in the kinematic chain, the jack continues to push with increased intensity and may damage one or more elements of the mechanism for transmitting the movement, or even more. A frangible part, having a weak point that can withstand up to a certain force threshold is provided in the fitting. Beyond this threshold, the part breaks and allows the jack to continue its stroke so as to not damage the overall system, in both directions of displacement of the jack.

### CROSS-REFERENCES TO RELATED APPLICATIONS

This application claims the benefit of the French patent application No. 1754281 filed on May 16, 2017, the entire disclosures of which are incorporated herein by way of reference.

### BACKGROUND OF THE INVENTION

The present invention relates to the field of mechanical control systems having a jack for the displacement of an actuator, and more specifically to the attachment of the control systems to fixed structures. The present invention relates, in particular, to lever-type actuators.

In a great many technical fields, jacks are used to permit the mechanical displacement of an actuator. FIG. 1 shows a possible embodiment of a known type of jack 2. The jack 2 comprises a body 4 within which a mobile part, called the piston 6, moves in translation. A rigid rod 8 is attached to the piston 6 and serves for transmitting the displacement and the forces. One of the ends 10 of the jack is linked directly or indirectly to a fixed structure 12 as a support. The other end 14 of the jack consists of the rod 8 of the piston 6, which is able to move in translation within the body 4 over a distance equivalent to the stroke of the piston 6, which is considered to be the stroke of the jack.

The actuator 16 can be of any possible type and is, for example, in the form of a lever 16. One of the ends 18 of the lever is connected to the rod 8 of the jack. The displacement of the piston 6 causes that of the lever 16, which pivots about a fixed axis 20.

When the stroke of the jack is impeded by a problem in the kinematic chain, the jack continues to push with increased intensity and may damage one or more elements of the mechanism for transmitting the movement, or even more.

One solution involves dimensioning all of the elements of the mechanism serving the operation of the actuator so as to withstand the maximum force that can be provided by the jack.

Where this is geometrically possible, it results in elements whose volume and weight are greater than that necessary for normal running operation of the jack.

The present invention has an object of proposing an alternative by which it is possible to alleviate the problem of damage in the event of the jack being blocked, without it being necessary to strengthen the elements thereof.

### SUMMARY OF THE INVENTION

To that end, the present invention proposes a fitting intended to provide the support necessary for the operation of a translation control system for the displacement of an actuator, wherein the fitting comprises two portions, one portion referred to as the fixed portion, that is intended for connecting to a fixed structure, and a portion referred to as the mobile portion, that is intended for connecting to the control system, the fixed portion and the mobile portion being joined to one another by means of a frangible pin that is dimensioned so as to break when a predetermined force level, exerted on the mobile portion, is reached, at least one cutout being provided between the fixed portion and the mobile portion at the periphery of their opposing faces, referred to as peripheral faces, while the central portions of the faces of the fixed portion and of the mobile portion, referred to as central faces, touch so as to provide the connection by means of the pin.

The fitting has at least one of the following optional features, considered in isolation or in combination.

The pin has a transverse contraction at the level of the connection between the central portions of the touching faces of the fixed and mobile portions.

At least two stops are provided distributed about the pin, equidistant therefrom at the level of the cutout, projecting from the peripheral face of the fixed portion, and coming to bear against the peripheral face of the mobile portion so as to immobilize it with respect to the fixed portion while bringing about a moment of rotation of the mobile portion about each of the stops.

The stops are in the form of rods passing through at least part of the fixed portion to project into the cutout and come to bear against the mobile portion.

The longitudinal direction of each rod is perpendicular to the direction of the plane formed by the peripheral face of the mobile portion at the point at which the rod comes to bear.

The central and peripheral faces respectively of the fixed portion and the mobile portion are in the shape of a hat allowing the mobile portion to fit into the fixed portion, the central faces touching while the peripheral faces are spaced apart from one another.

The fixed and mobile portions are hollow so as to allow the pin to project into the mobile portion on one hand and the fixed portion on the other hand

The overall shape of the fitting is parallelepipedal with an isosceles triangular base.

The present invention also relates to the installation comprising a fitting having the above features, wherein one of the ends of the fitting corresponding to one of the ends of the fixed portion is connected to a fixed component, and the opposite end thereof, corresponding to an end of the mobile portion, is connected in a manner articulated in rotation about an axis to a translation control system for an actuator.

The control system can, according to one possible embodiment, be in the form of a jack that is positioned with respect to the fitting such that the longitudinal axis Y-Y of the jack is not parallel to the longitudinal axis Z-Z of the pin of the fitting.

### BRIEF DESCRIPTION OF THE DRAWINGS

Further objects, advantages and features of the invention will become apparent from reading the following description given by way of non-limiting example and with reference to the attached drawings, in which:

FIG. 1 is a simplified schematic plan view of a jack installed between a fixed structure and an actuator according to the prior art;

FIG. 2 is a simplified schematic plan view of a jack installed, as in FIG. 1, between a fixed structure and an actuator by the intermediary of a fitting according to the present invention;

FIG. 3 is a simplified schematic view in section of the fitting shown in FIG. 2, highlighting the two portions, fixed and mobile, of the fitting shown in FIG. 2, these being connected by a frangible pin;

FIGS. 4 and 5 are simplified schematic views in section of the fitting, showing the forces exerted thereon by the jack when the jack respectively pushes or pulls on the fitting.

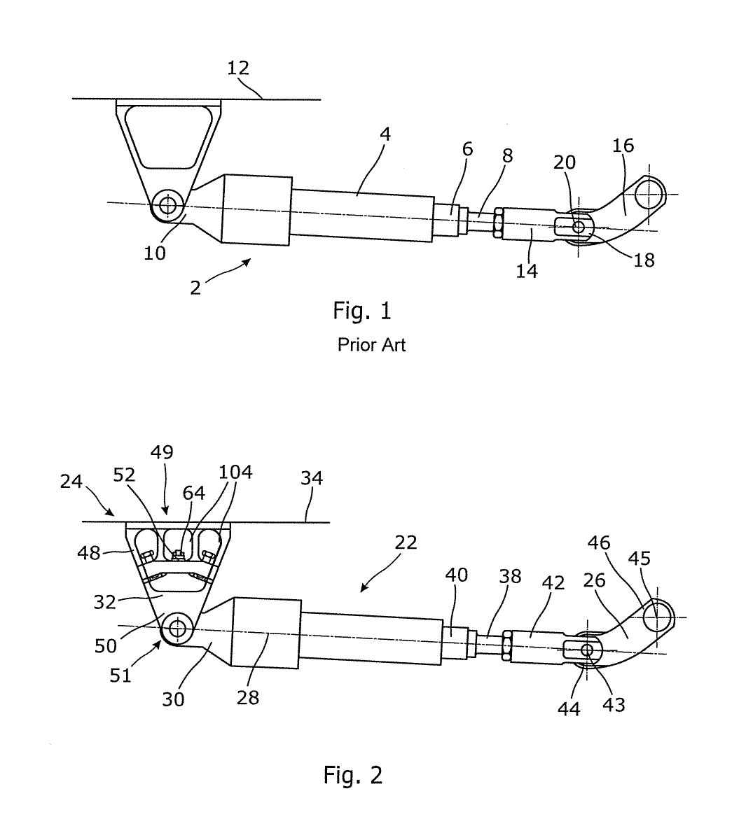

### DETAILED DESCRIPTION OF THE PREFERRED EMBODIMENTS

FIG. 2 shows a system 22 for driving in translation, supported by a structure 24 to allow the displacement in rotation of a device 26 articulated in rotation, for example of the lever type. The drive system 22 comprises a jack 28, of which one of the ends 30 is attached to a fitting 32 connected to a fixed component 34. The component 34 is identified as fixed with respect to the movement of the system 22 to which it is connected indirectly by the fitting 32. The component 34 forms, with the fitting 32, the structure 24 which supports the jack. The jack 28 comprises a rigid rod 38 which is attached to the piston 40 of the jack 28 and serves for transmitting the displacement and the forces. The other end 42, formed by the rod 38 of the jack, is linked, in a manner articulated in rotation about an axis 43, to one of the ends 44 of the lever 26. The other end 46 of the lever 26 is joined, in a manner articulated in rotation about an axis 45, to a mechanism which it actuates when it moves.

Together, these elements form a kinematic chain. If a blockage point appears in the chain, the push or pull force of the jack increases and can damage the system as a whole, as seen previously. One principle of the present invention is to release additional play for the stroke of the jack in the event of a blockage subjecting the elements of the chain to excessive forces.

The system for releasing the stroke of the jack is brought about by inserting, into the kinematic chain, a part, referred to as a shear pin, having a weak point that can withstand up to a certain force threshold. Beyond this threshold, the part breaks and allows the jack to continue its stroke so as to not damage the overall system. The release system must operate in both directions of displacement of the jack, that is to say, both when it is pushing and when it is pulling the lever.

The system for freeing the travel of the jack is provided at the fixed structure 24. The jack 28 is supported by the structure 24 when it pushes on the lever 26, or is retained by the structure when it pulls on the lever: thus, the structure 24 is designed to be able to move from a certain force level of the jack 28, thus removing the support or the retention: the travel of the jack is no longer impeded and can continue to move without damaging an element of the chain.

The fitting 32 comprises two portions: a “fixed” portion 48 connected to the component 34 and a “mobile” portion 50 connected to the jack 28. The component 34 and the jack 28 are respectively linked to the fixed portion 48 and to the mobile portion 50 at two opposite ends 49, 51 of the fitting. The fixed portion 48 and the mobile portion 50 of the fitting 32 are joined between the two ends 49, 51 by means of a frangible pin 52. The dimensions of the pin 52 are such that it breaks at the connection between the fixed and mobile portions 48 and 50 of the fitting 32 when a predetermined force threshold, applied to the mobile portion, is reached. The pin 52 has a transverse contraction 53 at a median portion 55 of the pin. The median portion 55 of the pin is located, once the pin is installed, in a plane X-X at which an external face 54 of the fixed portion 48 and an external face 56 of the mobile portion 50 of the fitting 32 touch. The contraction 53 can have a certain dimension in the longitudinal direction of the pin 52 and can extend on either side of the plane X-X. In the form shown, the contraction is progressive in the longitudinal direction of the pin 52, in the sense from each end of the axis to the contraction 53: the pin 52 gradually contracts transversely in its median portion in both senses until it reaches the contraction 53, having the smallest dimension, positioned in the plane X-X when the pin is installed. The pin has, in the median portion 55, an inverted double frustoconical shape (on either side of the plane X-X): the inverted frustoconical portions meet at the contraction 53. The jack 28 pushes or pulls the mobile portion 50 connected to the fixed portion by the pin 52. When the maximum force threshold that the pin 52 can withstand is reached, the pin breaks at the contraction 53, thus separating the mobile portion 50 from the fixed portion 48 and hence releasing the travel of the jack 28 which no longer has any support or retention on the mobile portion 50 of the fitting.

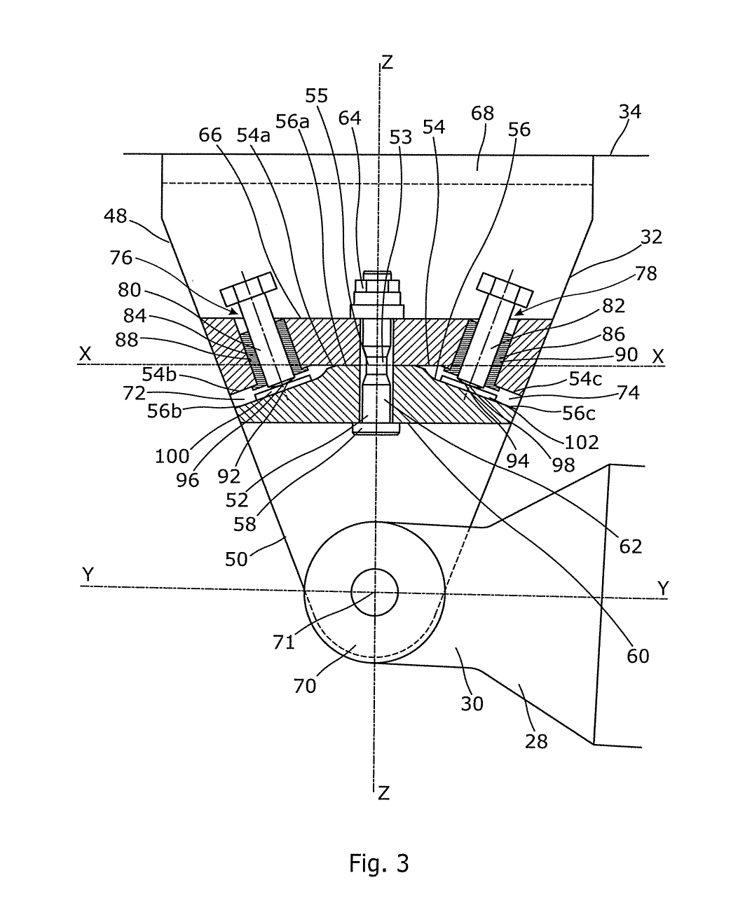

As shown in FIG. 3, the jack 28 is positioned with respect to the fitting 32 such that the longitudinal axis Y-Y of the jack is not parallel to the longitudinal axis Z-Z of the pin 52. In the embodiment shown, the axis Y-Y is perpendicular to the axis Z-Z.

The pin 52 comprises a head 58 whose edges press against an internal face 60 of the mobile portion 50 of the fitting, parallel to the external face 56 of the mobile portion. The pin 52 has an at least partially threaded shank 62, at one end of which is the head 58. On the opposite side from the head 58, a swivel nut 64 is provided on the pin 52 to join together the fixed 48 and mobile 50 portions. In the example shown, only that portion of the shank 62 receiving the nut 64 is threaded. Furthermore, the swivel nut 64 is just one possible example: any other type of nut such as a conventional nut might also be used. The fixed and mobile portions 48 and 50 are hollow so as to receive the head 58 and the nut 64 in order to hold the fixed portion 48 against the mobile portion 50 of the fitting 32. The nut 64 rests against an internal face 66 of the fixed portion that is parallel to the face 54 of the fixed portion. The faces 54, 56, 60 and 66 are at least partially parallel to one another when the fixed and mobile portions of the fitting are held in the assembled state by the pin.

The fitting may be of any shape having the stated features.

According to the embodiment shown, the fixed and mobile portions form a parallelepipedal part of which the base has the overall shape of an isosceles triangle; one of the sides 68 forming the base of the triangle is attached to the fixed component 34 and the main vertex 70 opposite the side 68 is joined in a manner articulated in rotation to the jack 28 about an axis 71. The side 68 and the apex 70 form the opposite ends 49 and 51 of the fitting.

So as to load the pin 52 in tension and not in shear, a cutout 72, 74 is provided between the fixed portion and the mobile portion about the pin 52. In the case of a fitting having an asymmetric surface, the cutout extends all the way around the pin 52. In the embodiment shown, the cutout is in the form of two cavities 72, 74 on either side of the pin 52, specifically on either side of the axis Z-Z, symmetrically with respect thereto. The cutout 72, 74 is created at the connection between the fixed portion and the mobile portion of the fitting; thus, the faces 54 and 56 do not touch over their entire surface.

In the embodiment shown, the faces 54 and 56 each have a central portion 54a, 56a touching the other, in the middle of which portion is the pin 52, and two peripheral portions 54b, 56b and 54c, 56c. The portions 54b, 56b and 54c, 56c are therefore respectively spaced apart from one another to form the respective cavities 72 and 74. Thus, the faces 54 and 56 touch in a central region and are spaced apart at the periphery. The cutout may be of any shape and for example, as shown, may have an essentially V-shaped profile in section in the plane defined by the axes X-X and Z-Z. In the rest of the description, the central portions of the faces 54, 56, which touch one another, will be referred to as the central faces and will be designated in the depicted embodiment by references 54a and 56a, and the peripheral portions of the faces 54, 56, which are spaced apart from one another, will be referred to as the peripheral faces and will be designated in the depicted embodiment by references 54b, 54c, 56b, 56c.

Faces 54 and 56 are each in the shape of a hat so as to fit overall one inside the other. In the depicted embodiment, the peripheral faces 54b, 54c (and, respectively, 56b, 56c) form an angle with the X-X axis while the central faces 54a (and, respectively, 56a) are in the direction of the X-X axis, the central faces 54a and 56a touching one another. The peripheral faces 54b, 54c (and, respectively, 56b, 56c) are inclined from the central face 54a (and, respectively, 56a) towards the exterior of the fitting. They are inclined such that, as one approaches the apex 70 in the direction Z-Z, the external surface of the fitting at the peripheral faces 54b, 54c, 56b, 56c is further removed from the pin 52 or from the Z-Z axis.

As seen previously, any other shape which serves to perform the stated functions is possible for the fitting. The central face and each of the peripheral faces 54a, 54b, 54c (and, respectively, 56a, 56b, 56c), have approximately the same transverse dimension (along the X-X axis); in the depicted embodiment, the central face 54a (and, respectively, 56a) is smaller than the peripheral faces 54b and 54c (and, respectively, 56b and 56c).

As shown in FIG. 3, stops 76, 78 are provided on either side of and equidistant from the pin 52, in order to immobilize the mobile portion with respect to the fixed portion, taking into account the presence of the cutout 72, 74 and the weakness at the contraction 53 of the pin. The stops form projections that stand proud of the surface of the peripheral face of the fixed portion, either in the depicted example from the faces 54b, 54c and dimensioned such that they come to abut against the peripheral face 56 of the mobile portion opposite, or in this case from the faces 56b, 56c: the stops allow the pin to break only under a certain level of force exerted by the jack. In the embodiment shown, the stops 76, 78 are respectively in the form of two threaded rods 80, 82 in corresponding sleeves 84, 86 that are inserted respectively into a bore 88, 90 provided in the fixed portion of the fitting on either side of the pin 52, or on either side of the axis Z-Z, equidistant therefrom. Each rod 80, 82 passes through the bore 88, 90 provided in the fixed portion to project into each of the cavities 72, 74 and come to press at least part of its end face 92, 94 against the peripheral face 56 of the mobile portion and, in the depicted embodiment, of each face 56b, 56c thereof The longitudinal direction of the rods 80, 82, of the sleeves 84, 86 and of the bores 88, 90 is essentially perpendicular to the plane formed by the peripheral faces 56b, 56c of the mobile portion. It can be arranged in another direction. The pressure of the stop against the mobile portion brings about a moment of rotation, about the stop, exerted by the jack. In the depicted embodiment, the rods 80, 82 of the stops 76, 78 are respectively in a direction parallel to that of each of the two external sides of the fitting, meeting at the apex 70 of the triangle formed by the fitting. The central longitudinal axes of the rods 80, 82 and of the pin 52 are coplanar.

The stops 76, 78 are adjustable by virtue of the thread but could be fixed and non-adjustable if adequate machining and assembly tolerances are guaranteed.

The end face 92, 94 of each of the rods 80, 82 of the stops 76, 78 is shaped such that a small portion thereof is in contact with the respective peripheral face 56b, 56c of the mobile portion so as to form a respective axis of rotation 96, 98 of the mobile portion about the respective stop 76, 78. In the depicted embodiment, the face 92, 94 is curved.

In the embodiment depicted in FIG. 3, the peripheral faces 56b, 56c of the mobile portion are also provided with a small respective protuberance 100, 102 in order to receive the respective end face 92, 94 of the respective stop 76, 78.

As shown in FIG. 2, at least one window 104 is created in the fixed portion so as to provide access to the hollow region thereof in which are located the pin 52 and also the rods 80, 82 of the stops.

The system operates as follows:

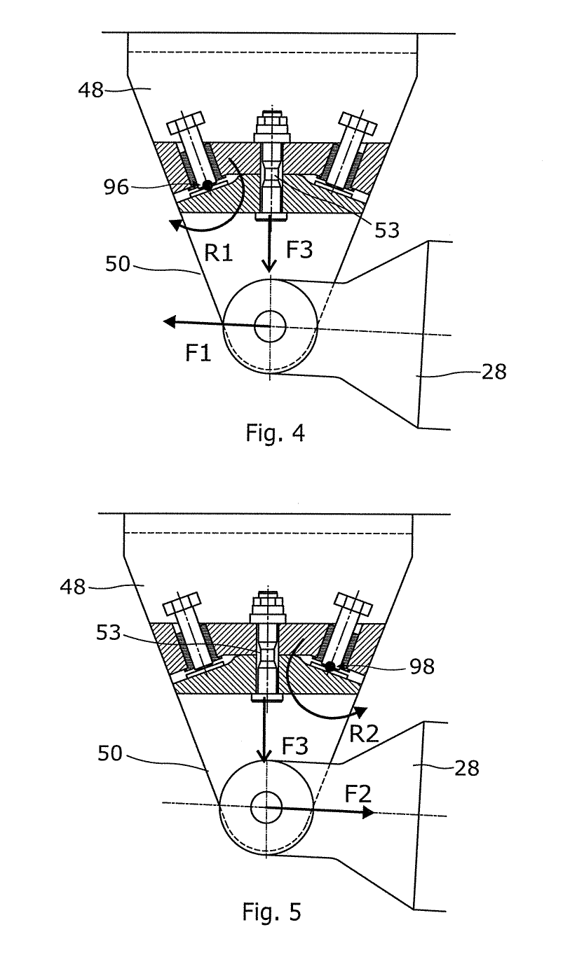

When the jack 28 exerts a push force F1 (FIG. 4) or a pull force F2 (FIG. 5) on the mobile portion 50 of the fitting 32, the force causes a moment of rotation R1 (FIG. 4) or R2 (FIG. 5) about the axis 96 (FIG. 4) or 98 (FIG. 5) and thus generates a tensile force F3 on the pin 52 along the axis Z-Z. When the push force or pull force exerted by the jack exceeds the force which the pin 52 is able to withstand, the pin breaks at the contraction 53. The mobile portion 50 of the fitting then detaches from the fixed portion 48. The jack can continue its stroke unopposed, thus avoiding damage to an element of the kinematic chain.

The fitting acts as a shear pin that works in both directions of the stroke of the jack. It can be used with any type of jack. The simplicity and compactness of the system facilitate its implementation. The shear pin breaks via a tensile force under both a push or pull force by the jack 28, which improves precision compared to breaking under a shear force. The maximum force permitted by the fitting can be adapted quickly simply by replacing the pin thereof with a pin of different geometry, specifically having a contraction 53 that is suited to the new requirement. In the event of a fault, when the pin has broken, it is very easy to return the entire system to working order since only the pin is damaged. Therefore, all that is needed is to re-fit the mobile portion of the fitting onto the fixed portion using a new pin.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fitting configured to provide support a translation control system for displacement of an actuator, comprising:
two portions,
one portion referred to as a fixed portion configured to connect to a fixed structure, and
a portion referred to as a mobile portion configured to connect to the control system,
a frangible pin joining the fixed portion and the mobile portion to one another, the pin being dimensioned so as to break when a predetermined force level, exerted on the mobile portion, is reached,
at least one cutout provided between the fixed portion and the mobile portion at a periphery of their opposing faces, referred to as peripheral faces, while central portions of the opposing faces of the fixed portion and of the mobile portion, referred to as central faces, touch so as to provide a connection via the pin, and
wherein the central and peripheral faces of the fixed portion and the mobile portion are each in the shape of a hat allowing the mobile portion to fit into the fixed portion, the central faces touching each other while the peripheral faces are spaced apart from one another.

2. The fitting according to claim 1, wherein the cutout comprises two cavities, one on either side of and symmetrically configured with respect to the pin.

3. The fitting according to claim 1, wherein the pin has a transverse contraction in line with an interface between the touching central faces of the fixed and mobile portions.

4. The fitting according to one of claim 1, wherein at least two stops are provided, distributed about the pin and equidistant therefrom in line with the cutout, each projecting from the peripheral face of the fixed portion, and coming to bear against the peripheral face of the mobile portion so as to immobilize the mobile portion with respect to the fixed portion while bringing about a moment of rotation of the mobile portion about each of the stops.

5. The fitting according to claim 4, wherein the stops comprise rods passing through at least part of the fixed portion to project into the cutout and coming to bear against the mobile portion.

6. The fitting according to claim 5, wherein a longitudinal direction of each rod is perpendicular to a direction of a plane formed by the peripheral face of the mobile portion at a point at which the rod comes to bear.

7. The fitting according to claim 1, wherein the fixed and mobile portions are hollow so as to allow the pin to project into the mobile portion and the fixed portion.

8. The fitting according to claim 1, wherein an overall shape of the fitting is parallelepipedal with an isosceles triangular base.

9. An installation comprising a fitting according to claim 1, wherein an end of the fitting corresponding to an end of the fixed portion is connected to a fixed component, and an opposite end thereof, corresponding to an end of the mobile portion, is connected in a manner articulated in rotation about an axis to a translation control system for an actuator.

10. The installation according to claim 9, wherein the control system comprises a jack that is positioned with respect to the fitting such that a longitudinal axis of the jack is not parallel to a longitudinal axis of the pin of the fitting.
